(19) United States
(12) Patent Application Publication
(10) Pub. No.: US 2024/0043313 A1
(43) Pub. Date: Feb. 8, 2024

(54) ALKALI DOPED OPTICAL FIBER WITH REDUCED ATTENUATION

(71) Applicant: CORNING INCORPORATED, Corning, NY (US)

(72) Inventors: Sushmit Sunil Kumar Goyal, Painted Post, NY (US); Craig Daniel Nie, Horseheads, NY (US); Pushkar Tandon, Painted Post, NY (US)

(21) Appl. No.: 18/226,816

(22) Filed: Jul. 27, 2023

Related U.S. Application Data
(60) Provisional application No. 63/395,507, filed on Aug. 5, 2022.

(51) Int. Cl. C03B 37/012

(52) U.S. Cl. CPC C03B 37/01245; C03B 37/01262; C03B 2201/50

(57) ABSTRACT

A method of manufacturing an optical fiber, the method includes drawing a first optical fiber preform at a first draw tension to produce a first alkali doped optical fiber and drawing the first optical fiber preform at a second draw tension to produce a second alkali doped optical fiber, measuring the attenuation of the first alkali doped optical fiber and the second alkali doped optical fiber such that the second alkali doped optical fiber has a lower attenuation. Additionally, the method includes setting the draw tension to the second draw tension and drawing a second optical fiber preform at the second draw tension to produce a third alkali doped optical fiber. The third alkali-doped optical fiber has an attenuation at 850 nm of about 1.50 dB/km or less and an attenuation at 1550 nm of about 0.155 dB/km or less.

This application claims the benefit of priority under 35 U.S.C § 120 of U.S. Provisional Application Ser. No. 63/395,507 filed on Aug. 5, 2022, the content of which is relied upon and incorporated herein by reference in its entirety.

### FIELD OF THE DISCLOSURE

This disclosure pertains to optical fibers. More particularly, this disclosure pertains to alkali doped optical fibers with reduced attenuation.

### BACKGROUND OF THE DISCLOSURE

Optical fibers have acquired an increasingly important role in the field of communications and operate by propagating a beam of light. Typically an optical fiber comprises a core and cladding. The core is used to propagate the light, and the cladding is used to contain the light within the core through reflection.

Optical fibers must operate within very specific waveguide parameters, including low attenuation loss, in order to transmit a signal over long distances and within a short period of time. Attenuation is the loss of a signal within the optical fiber. Therefore, attenuation of an optical fiber is a measure of the amount of light loss between an input and output of the fiber. The attenuation of an optical fiber is a result of the fiber's absorption, scattering properties, and bending losses, which are each influenced by the materials of the fiber and the fiber structure itself.

### SUMMARY

Aspects of the present disclosure provide an optical fiber with reduced attenuation. For example, and as discussed further below, aspects of the present disclosure include doping the optical fiber with alkali, regulating the temperature of the optical fiber downstream of a draw furnace, and/or optimizing the draw tension at which the optical fiber is drawn. These features each contribute to a lower attenuation in the final, drawn optical fiber. More specifically, these features each contribute to providing reduced attenuation at 850 nm and 1550 nm wavelengths in the final, drawn optical fiber.

In embodiments, optimizing the draw tension, to provide the reduced attenuation, may include lowering the draw tension. However, relatively lower draw tensions typically require that the fiber be drawn at elevated temperatures, which can increase the hydrogen sensitivity of the optical fiber. More specifically, such elevated temperatures can cause an increased number of oxygen-rich non-bridging oxygen defects in the fiber. These oxygen-rich non-bridging oxygen defects are known to react with hydrogen to form hydroxyl groups. The formation of hydroxyl groups are undesirable as hydroxyl groups absorb wavelengths within the telecommunications window and, thus, result in increased attenuation of an optical signal. The concentration of the oxygen-rich non-bridging oxygen defects is reflected in the attenuation measured at 850 nm.

Therefore, aspects of the present disclosure further include incorporating a reducing agent in the optical fiber to reduce the hydrogen sensitivity of the optical fiber.

Embodiments of the present disclosure are directed to a method of manufacturing an optical fiber, the method comprising forming an alkali-doped silica-containing glass tube, collapsing the glass tube to form a first glass rod, depositing silica soot on the first glass rod to form a first glass body, depositing additional silica soot on the first glass body, exposing the silica soot on the first glass body to a halide dopant, exposing the silica soot on the first glass body to a reducing agent, consolidating the silica soot on the first glass body to form a first preform precursor, and forming a first optical fiber preform from the first preform precursor. The method further comprises drawing the first optical fiber preform at a first draw tension to produce a first alkali doped optical fiber and drawing the first optical fiber preform at a second draw tension to produce a second alkali doped optical fiber, measuring the attenuation of the first alkali doped optical fiber and the second alkali doped optical fiber such that the first alkali doped optical fiber has a first measured attenuation and the second alkali doped optical fiber has a second measured attenuation, the second measured attenuation being less than the first measured attenuation. Additionally, the method comprises setting the draw tension to the second draw tension and drawing a second optical fiber preform made with a similar process as the first optical fiber preform at the second draw tension to produce a third alkali doped optical fiber. The third alkali-doped optical fiber has an attenuation at 850 nm of about 1.50 dB/km or less and an attenuation at 1550 nm of about 0.155 dB/km or less. In some embodiments, the first glass rod is doped with alkali chosen from a group comprising sodium, potassium, rubidium or combination thereof.

Embodiments of the present disclosure are directed to a method of manufacturing an optical fiber, the method comprising forming an alkali-doped silica-containing glass tube, collapsing the glass tube to form a first glass rod, depositing silica soot on the first glass rod to form a first glass body, depositing additional silica soot on the first glass body, exposing the silica soot on the first glass body to a halide dopant, exposing the silica soot on the first glass body to a reducing agent, consolidating the silica soot on the first glass body to form a first preform precursor, and forming a first optical fiber preform from the first preform precursor. The method further comprises drawing the first optical fiber preform at a first draw tension to produce a first alkali doped optical fiber and drawing the first optical fiber preform at a second draw tension to produce a second alkali doped optical fiber, measuring the attenuation of the first alkali doped optical fiber and the second alkali doped optical fiber such that the first alkali doped optical fiber has a first measured attenuation and the second alkali doped optical fiber has a second measured attenuation, the second measured attenuation being less than the first measured attenuation. Additionally, the method comprises setting the draw tension to the second draw tension and drawing a second optical fiber preform at the second draw tension to produce a third alkali doped optical fiber. The third alkali-doped optical fiber has an attenuation at 850 nm of about 1.50 dB/km or less and an attenuation at 1550 nm of about 0.155 dB/km or less. In some embodiments, the first glass rod is doped with an alkali comprising at least one of sodium, potassium, rubidium, cesium, lithium, or a combination thereof.

Embodiments of the present disclosure are directed to a method of manufacturing an optical fiber, the method comprising forming an alkali-doped silica-containing glass tube, collapsing the glass tube to form a glass rod, depositing silica soot on the glass rod to form a glass body, depositing additional silica soot on the glass body, exposing the silica soot on the glass body to a halide dopant, exposing the silica soot on the glass body to a reducing agent, consolidating the silica soot on the glass body to form a preform precursor, forming an optical fiber preform from the preform precursor, and drawing the optical fiber preform into an alkali-doped optical fiber at a draw tension of about 60 grams to about 90 grams. The method further comprises exposing the alkali-doped optical fiber to a cooling apparatus for a duration of about seconds or greater, the cooling apparatus being downstream of a draw furnace and operating within a range between about 900° C. and about 1300° C. The alkali-doped optical fiber has an attenuation at 850 nm of about 1.50 dB/km or less and an attenuation at 1550 nm of about 0.155 dB/km or less.

Embodiments of the present disclosure are directed to a method of manufacturing an optical fiber, the method comprising forming an alkali-doped silica-containing glass tube, collapsing the glass tube to form a glass rod, depositing silica soot on the glass rod to form a glass body, depositing additional silica soot on the glass body, exposing the silica soot on the glass body to a halide dopant, exposing the silica soot on the glass body to a reducing agent, consolidating the silica soot on the glass body to form a preform precursor, forming an optical fiber preform from the preform precursor, and drawing a first portion of the optical fiber preform into first alkali-doped optical fiber at a first draw tension and drawing a second portion of the optical fiber preform into a second alkali-doped optical fiber at a second draw tension, the second drawn tension being lower than the first draw tension. The second alkali-doped optical fiber has an attenuation at 850 nm of about 1.50 dB/km or less and an attenuation at 1550 nm of about 0.155 dB/km or less. In some embodiments, the second portion comprises greater than 60% of the preform. In some embodiments, the first draw tension is between 100 g and 200 g and the second draw tension is between 40 g and 50 g.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 is a schematic, cross-sectional view of an optical fiber, according to embodiments of the present disclosure;

FIG. 2 is a schematic view of a fiber production system, according to embodiments of the present disclosure;

FIG. 3 is a plot of position along a fiber draw vs. attenuation at 1550 nm for a plurality of optical fibers;

FIG. 4 is a process to produce an optical fiber with reduced attenuation, according to embodiments of the present disclosure;

FIG. 5 is another process to produce an optical fiber with reduced attenuation, according to embodiments of the present disclosure;

FIG. 6 is another process to produce an optical fiber with reduced attenuation, according to embodiments of the present disclosure; and

FIG. 7 is another process to produce an optical fiber with reduced attenuation, according to embodiments of the present disclosure.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:

“Optical fiber” refers to a waveguide having a glass portion, wherein the glass portion includes at least a core portion.

The “mode field diameter” or “MFD” of an optical fiber is defined as:

$$M F D = 2 w$$

$${w}^{2} = 2 \frac{{\int }_{0}^{∞} {( f ( r ) )}^{2} r d r}{{\int }_{0}^{∞} {( \frac{d f ( r )}{d r} )}^{2} r d r}$$

where f(r) is the transverse component of the electric field distribution of the guided optical signal and is calculated from the refractive index profile of the fiber, as is known in the art, and r is radial position in the fiber. “Mode field diameter” or “MFD” depends on the wavelength of the optical signal and is reported herein for wavelengths of 1310 nm and 1550 nm. Specific indication of the wavelength will be made when referring to mode field diameter herein. Unless otherwise specified, mode field diameter refers to the LP₀₁ mode at the specified wavelength. “Effective area” of an optical fiber is defined as:

$${A}_{eff} = \frac{2 {π [ {\int }_{0}^{∞} {( f ( r ) )}^{2} r d r ]}^{2}}{{\int }_{0}^{∞} {( f ( r ) )}^{4} r d r}$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm.

The term “attenuation,” as used herein, is the loss of optical power as the signal travels along the optical fiber. Attenuation is measured as specified by the IEC-60793-1-40 standard, “Attenuation measurement methods.”

“Cable cutoff wavelength,” or “cable cutoff,” as used herein, refers to the 22 m cable cutoff test as specified by the IEC 60793-1-44 standard, “Measurement methods and test procedures—Cut-off wavelength.”

The optical fibers disclosed herein include a core region and may further include a cladding region surrounding the core region and a coating surrounding the cladding region. The core region and cladding region are each formed of glass. The cladding region may include multiple concentric regions. In some embodiments, the multiple regions include one or more trench regions comprising a depressed-index cladding region. The coating may include at least a primary coating and a secondary coating. Furthermore, the optical fibers disclosed herein may be single-mode optical fibers or multi-mode optical fibers. As discussed further below, the optical fibers disclosed herein are formed from an optical fiber preform using a draw process.

FIG. 1 depicts a cross-section of an exemplary optical fiber 10. As shown in FIG. 1, fiber 10 comprises a core 12, an inner cladding 14, and an outer cladding 16. In some embodiments, fiber 10 further comprises a trench region (depressed-index cladding region) between inner cladding 14 and outer cladding 16. Core 12 may be a glass body formed of, for example, silica glass that is either un-doped silica glass, up-doped silica glass, and/or down-doped silica glass. Up-doped silica glass includes silica glass doped with, for example, germanium (e.g., GeO₂), phosphorus (e.g., P₂O₅), aluminum (e.g. Al₂O₃), chlorine (Cl), and/or an alkali metal, as discussed further below.

Inner cladding 14 surrounds core 12 such that inner cladding is continuously disposed between core 12 and outer cladding 16. Core 12 may have a higher relative refractive index than inner cladding 14 and outer cladding 16. Thus, the refractive index of core 12 (Δ_{1,max}%), the refractive index of inner cladding 14 (Δ₂%), and the refractive index of outer cladding 16 (Δ₃%) follow the relations Δ_{1,max}%>Δ₂% and Δ_{1,max}%>Δ₃%. Furthermore, in some embodiments, Δ_{1,max}%>Δ₃%>Δ₂%. In some embodiments inner cladding 14 has a discernible core-cladding boundary with core 12. However, it is also contemplated that inner cladding 14 can lack a distinct boundary with core 12. Similarly, inner cladding 14 may have a discernible core-cladding boundary with outer cladding 16 or may lack a distinct boundary with outer cladding 16.

One or more coating layers may further be disposed on outer cladding 16 such that an outermost layer of the coating layer(s) is the outermost layer of fiber 10. The coating layer(s) may each be a polymeric material.

Core 12 may comprise one or more alkali metal dopants such that an average concentration of alkali metal dopants in core 12 is between about 50 ppm and about 500 ppm, or between about 100 ppm and about 450 ppm, or between about 150 ppm about 400 ppm. The average alkali concentration in the light carrying region may be defined as:

$${C}_{alkali , avg} = \frac{8 {\int }_{0}^{M F D / 2} {C}_{alkali} ( r ) r d r}{M F {D}^{2}}$$

where Cₐₗₖₐₗᵢ(r) is the concentration of the alkali as a function of the radial position and MFD is the mode field diameter of the optical fiber at 1550 nm. In some embodiments, the concentration of the alkali metal dopants decreases with a radius of the core. Therefore, the concentration of the dopant is highest at the centerline of fiber 10. The alkali metal dopant may be, for example, one or more of sodium, potassium, lithium, cesium, and rubidium. Additionally or alternatively, the alkali metal source comprises bromide, iodide, fluoride, or combinations thereof. The alkali metal dopant may be a metal oxide of these alkali metals, such as Na₂O, K₂O, Li₂O, Cs₂O, Rb₂O, or mixtures thereof. In some embodiments, the alkali metal is KBr, KI, KNO₃ or mixtures thereof. The incorporation of the alkali metal dopant in core 12 reduces the attenuation of fiber 10. Specifically, the alkali metal dopant lowers the viscosity of core 12, which increases glass relaxation in the glass transition region during optical fiber drawing. The increased glass relaxation of the core 12 during the draw reduces the glass fictive temperature, thus causing a reduction in Rayleigh scattering and attenuation.

Core 12 may further comprise additional dopants in addition to the alkali metal dopant. For example, core 12 may comprise chlorine and/or fluorine as a dopant. Furthermore, inner cladding 14 and/or outer cladding 16 may be doped with one or more dopants, such as a halide dopant. In some embodiments, the halide is fluorine.

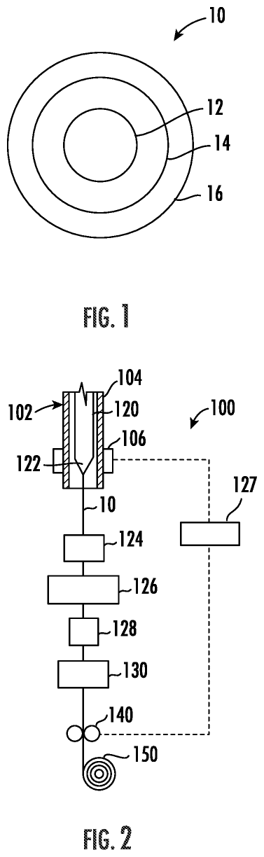

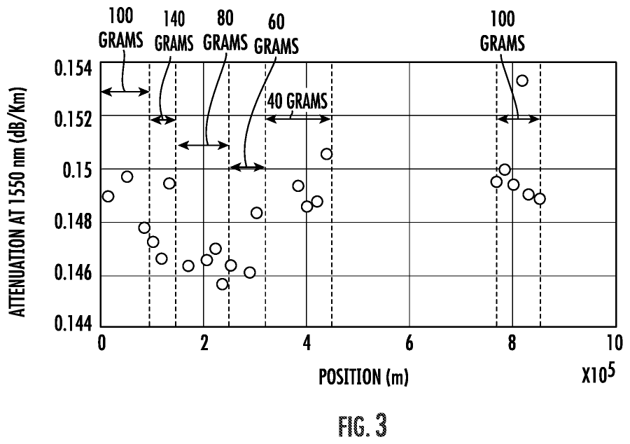

Optical fiber 10 may be produced by a fiber production system 100, as shown in FIG. 2. System 100 generally comprises a draw furnace 102 that includes a heating element 106 and a muffle 104. As shown in FIG. 2, a glass preform 120 is disposed vertically in muffle 104, and heating element 106 supplies heat to at least a bottom portion of preform 120. Optical fiber 10 (in the form of a bare, uncoated optical fiber) is then drawn from the heated preform 120.

In order to draw fiber 10, a root portion 122 of preform 120 is pulled by a tractor 140 and wound onto a spoon or reel 150. Tractor 140 may cause optical fiber 10 to be drawn at different draw tensions. System 100 may further comprise a tension controller 127 that, in some embodiments, adjusts a temperature of heating element 106 to achieve a desired drawn tension. Typically, an increase in the temperature of furnace 102 will cause a decrease in the tension of the drawn fiber, whereas a decrease in the temperature of furnace 102 will cause an increase in the tension of the drawn fiber. Additionally or alternatively, the draw tension may be modified by adjusting the speed of the fiber drawn by tractor 140, which may also be controlled by controller 127. In some embodiments, controller 127 may be responsive to a user selected tension setpoint. Therefore, in these embodiments, controller 127 may regulate heating element 106 and/or tractor 140 so that the drawing tension of preform 120 corresponds to the tension setpoint selected by the user. As discussed further below, the drawing tension of preform 120 may be selected to achieve a reduced attenuation in the drawn fiber.

System 100 may comprise additional components such as a monitor 124 to monitor and adjust the diameter of fiber 10. In some embodiments, monitor 124 is used to regulate a speed of tractor 140 to maintain a constant diameter of fiber 10. Tension measurement device 126 may measure the tension of fiber 10 to maintain a desired a draw tension. System 100 may further comprise a cooling apparatus 128 and a coating apparatus 130. Fiber 10 is a bare, uncoated fiber until reaching coating apparatus 130, which may apply a polymeric-based coating to an outside surface of the bare optical fiber. The coated fiber may then pass through a coating curing apparatus (not shown) before being wound on reel 150.

Tractor 140 may cause fiber 10 to be drawn at different draw tensions. The inventors of the present disclosure discovered that reduced attenuation in an optical fiber can be achieved by optimizing the draw tension for that fiber. For example, as the draw tension decreases, the attenuation of the drawn optical fiber also generally decreases to a point. The embodiments of the present disclosure include methods to efficiently and quickly determine the optimal draw tension to produce the reduction in attenuation. The inventors of the present disclosure tested twenty-three fibers at different draw tensions (i.e., 40 grams, 60 grams, 80 grams, 100 grams, and 140 grams) to determine the minimum attenuation achieved. Each data point in FIG. 3 represents a different fiber. It is further noted that all of the twenty-three fibers tested were produced from the same preform using the same standard process. As shown in FIG. 3, the fibers drawn at a tension of 60 and 80 grams produced the lowest attenuation of the tested fibers. It is noted that a draw tension of 60 or 80 grams was not the lowest tension tested in FIG. 3. However, these draw tensions were found to provide the lowest attenuation for the tested fibers.

A reduction in draw tension may reduce attenuation in the drawn fiber by increased glass relaxation in the fiber's glass transition region. Furthermore, a reduction in draw tension reduces stress in the fiber and, therefore, reduces perturbations at a core-cladding interface in the drawn fiber. A reduction in these perturbations reduces small angle scattering in the drawn optical fiber, thus providing a reduced attenuation. However, the higher draw temperatures corresponding to lower draw tensions results in increased number of glass defect centers in the drawn optical fiber. Some of these defect centers directly contribute to the attenuation at 1550 nm. Furthermore, the oxygen rich non-bridging oxygen defects in the optical fiber increases the hydrogen sensitivity of the optical fiber. Therefore, there is an optimal point at which the reduction in draw tension produces an optimal reduced attenuation.

Embodiments of the present disclosure comprise optimizing the draw tension during a fiber production process in order to produce fiber with reduced attenuation. In the embodiments disclosed herein, the draw tension to produce fiber 10 with reduced attenuation may be from about 50 grams to about 100 grams, or about 50 grams to about 90 grams, or about 50 grams to about 80 grams, or about 50 grams to about 70 grams, or about 60 grams to about 90 grams, or about 60 grams to about 100 grams, or about 60 grams to about 90 grams, or about 60 grams to about 80 grams, or about 60 grams to about 70 grams, or about 65 grams to about 95 grams, or about 65 grams to about 85 grams, or about 65 grams to about 75 grams, or about 55 grams to about 95 grams, or about 55 grams to about 85 grams, or about 55 grams to about 75 grams, or about 55 grams to about 65 grams, or about 55 grams to about 60 grams. Furthermore, in other embodiments, the draw tension to produce fiber 10 with reduced attenuation may be up to about 200 grams, or up to about 175 grams, or up to about 150 grams, or up to about 125 grams, or up to about 100 grams, or from about 50 grams to about 200 grams, or from about 100 grams to about 200 grams, or from about 150 grams to about 200 grams, or from about 175 grams to about 200 grams.

Although the optimized draw tensions, as discussed herein, may reduce attenuation, they may also result in an increased number of oxygen-rich non-bridging oxygen defects that contribute to hydrogen sensitivity of the fiber. More specifically, the relatively lower draw tensions, as discussed above, typically require relatively higher temperatures during the drawing process. The relatively higher temperatures are needed in order to provide the desired viscosity for achieving low tension in the optical fiber. However, such higher temperatures can cause an increase in fiber bond breakage during a fiber drawing process. More specifically, the higher draw temperatures cause cleavage of Si—O bonds in the fiber's silica matrix, thus forming non-bridging oxygen defects. A non-bridging oxygen defect is a dangling oxygen bond. Formation of a non-bridging oxygen defect may be schematically depicted as:

≡Si—O—Si≡→≡Si—O·+·Si≡

where “≡” signifies three coordination sites of silicon (usually occupied by oxygen), “.” signifies a radical, “.Si≡” is a dangling silicon bond (often referred to as an E′ defect), and “Si—O.” is a non-bridging oxygen defect (dangling oxygen bond). Hydroxyl groups may then form from the non-bridging oxygen groups in the presence of hydrogen through the reaction:

≡Si—O·+½H₂→≡SiOH

Hydroxyl groups (SiOH in the above reaction) are known to absorb wavelengths in the telecommunication window, thus increasing the attenuation of an optical fiber. Therefore, optimizing the draw tension during a fiber drawing process can reduce the attenuation of the drawn optical fiber. However, such a reduction in draw tension can also increase the hydrogen sensitivity of the fiber by forming non-bridging oxygen defect centers. The attenuation of the fiber can then increase again when the non-bridging oxygen groups are exposed to hydrogen, for example when the fiber is deployed during a fiber drawing process, and form hydroxyl groups. Furthermore, other defect centers formed during the draw process may also contribute to the attenuation increase at wavelengths in the telecommunication window, including at 1550 nm. In embodiments disclosed herein, the optimized draw tension resulting in lowest attenuation in an optical fiber corresponds to impact of stress on glass relaxation during the draw process, tension related perturbations at core-clad interface causing small angle scattering, and attenuation contribution from defect centers formed in the optical fiber.

As discussed further below, in order to combat the hydrogen sensitivity of the fiber, a reducing agent may be added to inner cladding 14 and/or outer cladding 16 during the production of the optical fiber. The reducing agent may comprise at least one of carbon monoxide (CO), silicon tetrachloride (SiCl₄), chloromethane (CH₃Cl), dichloromethane (CH₂Cl₂), chloroform (CHCl₃), or mixtures thereof. The reducing agent may be incorporated during the halide consolidation step, as discussed further below.

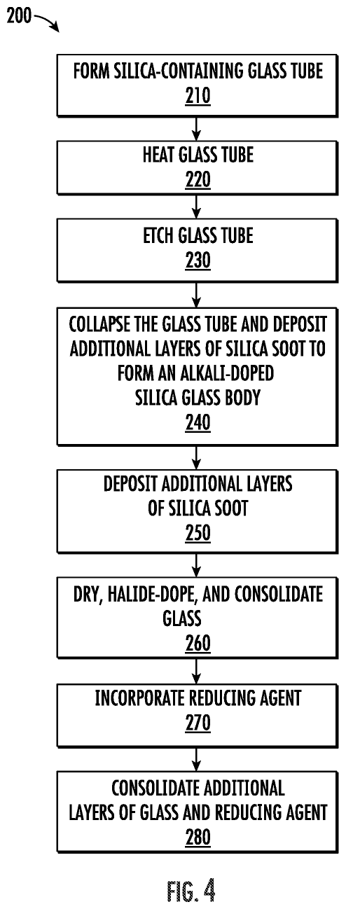

FIG. 4 depicts an exemplary process 200 to produce an optical fiber preform according to the embodiments disclosed herein using an outside vapor deposition (OVD) method. As shown in step 210, a silica-containing glass tube is formed. An alkali metal may be deposited on the inside of the tube by flowing alkali metal vapor through the tube and heating the tube from the outside using a traversing burner. The traversing burner heats the glass tube from the outside inward and facilitates diffusion of the alkali metal into the glass tube. The glass tube should be heated to a temperature sufficient to promote rapid diffusion of the alkali metal and to prevent devitrification. In some embodiments, the tube is heated to a temperature of at least about 1500° C., or at least about 1700° C., or at least about 2000° C.

The alkali metal may diffuse into the soot deposition layer to a depth of about 100 microns, or at least about 300 microns, or at least about 500 microns, or between about 100 microns and about 500 microns from an inside surface of the tube. The alkali metal oxide diffuses to a depth of between about 100 microns and 500 microns from the inside diffusion surface of the tube prior to collapse of the tube. In some embodiments, the diffused alkali metal oxide dopant concentration in the tube varies radially within the tube. For example, the tube may be doped such that the concentration of the alkali metal oxide is relatively higher in a radially inner half portion of the tube and relatively lower in a radially outer half portion of the tube. The demarcation point between the inner and outer half portions may be defined by and located at half the radial thickness of the tube. For example, the diffusion is preferably such that the peak concentration of the alkali metal oxide in the radial outer half portion is less than 50% of the peak concentration of the alkali metal oxide in the radial inner half portion.

Furthermore, the resulting silica glass tube, and any additional glass deposited therein, is “essentially free of water” such that “water” refers to the hydroxyl group OH. Water is responsible for an absorption peak at or about 1383 nm, which may extend into the telecommunication operating wavelength regions of an optical fiber. This peak may have a detrimental effect on the fiber attenuation. Therefore, it is desirable to reduce the absorption peak, also referred to as the water peak, by reducing the OH content of the glass tube as much as possible. Preferably, the glass tube contains less than about 100 ppb by wt. OH, and more preferably less than about 20 ppb by wt. To ensure that the glass tube is essentially free of water prior to diffusing the alkali metal oxide dopant, conventional chlorine drying techniques may be employed during manufacture of the glass tube.

As further shown in process 200, the diffusion of the alkali metal into the soot deposition layer may then be followed by a heating step (step 220) to partially collapse the glass tube and to consolidate the glass tube. By partially collapsing the glass tube, the surface area of an inner portion of the glass tube is reduced. Alkali metal can potentially move outward from the optical fiber through this inner portion of the fiber. The reduction in surface area of the inner portion helps to reduce any such movement of the alkali metal out of the fiber. Therefore, the partial collapse of the glass tube helps to reduce loss of the alkali metal.

At step 230, the glass tube is then etched with an etchant suitable for removing silica glass. The glass tube may be etched to a depth sufficient to remove unwanted impurities. In some embodiments, an HF solution or a fluoride gas may be used as the etchant. After the etching step, the glass tube is then further heated with a heat source at step 240 to collapse the tube and form an alkali-doped silica glass rod. Step 240 may further comprise depositing additional layers of silica soot on the glass rod to form a glass body. At the end of step 240, the produced alkali-doped silica glass body is the precursor to core 12 in the drawn optical fiber.

Additional layers of silica glass and dopants may then be deposited on the glass body (step 250) to form the cladding layers. For example, the additional layers of silica glass may be doped with a halide such as fluorine. Inner cladding 14 and outer cladding 16 may be formed on the core portion of the preform by the deposition of these additional layers of silica soot. In embodiments, the additional layers of silica soot may be formed by sleeving with a silica glass tube (either a glass tube or soot tube), depositing silica glass soot by chemical vapor deposition, both sleeving and chemical deposition, or through other methods as are known in the art. The additional layers of silica soot to form inner cladding 14 and outer cladding 16 may take several additional deposition steps to achieve the desired thickness, wherein after each deposition step, the silica soot is dried, halide doped, and consolidated (step 260). Inner cladding 14 and outer cladding 16 may also doped with a halide such as fluorine. The halide dopant may be provided to the silica glass as a halide-containing gas. After the final consolidation step in step 260, a preform precursor is formed.

Process 200 further includes at step 270 additional step of adding a reducing agent. As discussed above, the reducing agent is incorporated into the preform precursor to combat any hydrogen sensitivity of the fiber drawn therefrom. The reducing agent may be added to the silica soot simultaneously and during step 260 of process 200. In some embodiments, the reducing agent is incorporated into the silica soot that forms inner cladding 14 and/or outer cladding 16 in the drawn optical fiber. The reducing agent may be incorporated into the silica soot during the halide-doping step of step 260. In some embodiments, the halide is fluorine so that the reducing agent is incorporated into the silica soot during the fluorine doping step. In one exemplary embodiment, the reducing agent is incorporated into the silica soot that forms inner cladding 14 during the halide doping of this silica soot.

As discussed above, the silica soot of the preform precursor may be exposed to the reducing agent simultaneously as the silica soot is exposed to the dopant-containing gas. For example, the silica soot that forms inner cladding 14 may be exposed to the reducing simultaneously as this silica soot is exposed to the dopant-containing gas. In embodiments, the reducing agent is in gaseous form and mixed with a carrier gas, which may be an inert gas such as helium. The reducing agent may be mixed with the carrier gas such that the gas comprises at least about 1000 ppm of the reducing agent, or at least about 1500 ppm of the reducing agent, or at least about 2000 ppm of the reducing agent, or at least about 2500 ppm of the reducing agent, or at least about 3000 ppm of the reducing agent, or at least about 3500 ppm of the reducing agent, or at least about 4000 ppm of the reducing agent, or at least about 4500 ppm of the reducing agent, or at least about 5000 ppm of the reducing agent, or at least about 5500 ppm of the reducing agent. Additionally or alternatively, the gas comprises up to about 20,000 ppm of the reducing agent, or up to about 15,000 ppm of the reducing agent, or up to about 10,000 ppm of the reducing agent, or up to about 5,000 ppm of the reducing agent. In some embodiments, the gas comprises between about 2000 ppm and about 5500 ppm of the reducing agent, or between about 2500 ppm and about 5000 ppm of the reducing agent, or between about 3000 ppm and about 4500 ppm of the reducing agent. The balance of the gas may be the carrier gas.

In some embodiments, as discussed above, the silica soot that forms the cladding (i.e., inner cladding 14 and/or outer cladding 16) of optical fiber 10 is exposed to the reducing agent (when mixed with the carrier gas). The silica soot that forms the cladding may be exposed to the reducing agent for a treatment time between about 30 minutes and about 10 hours and at a temperature between about 800° C. and about 1500° C., or between about 1100° C. and about 1500° C., or between about 1300° C. and about 1500° C.

In some embodiments, the silica soot that forms inner cladding 14 and/or outer cladding 16 is exposed to the reducing agent during the consolidation step of step 260. For example, the reducing agent (when mixed with the carrier gas) may be present in the treatment chamber during the duration of the consolidation step. This exposure of the reducing agent during the consolidation step may be in place of or in addition to the exposure of the reducing agent during the halide-doping step of step 260.

The concentration of the reducing agent with the carrier gas, the temperature of treatment of the silica soot with the reducing agent, and the duration of treatment of the silica soot with the reducing agent are each chosen to provide a selected level of oxidation state reduction to the cladding in the drawn optical fiber.

After the incorporation of the reducing agent in the silica soot and after consolidation of the silica soot, in step 280 the preform precursor is then consolidated to form a final optical fiber preform. At this point, the completed optical fiber preform may be drawn into an alkali-doped and reducing agent-doped optical fiber (using system 100 as discussed above). Additional methods of forming alkali doped silica optical fibers are disclosed in U.S. Pat. Nos. 7,524,780, 7,469,559, and U.S. Patent Publication No. 2007/0297735, which are each hereby incorporated by reference in their entirety.

As discussed above, the incorporation of the reducing agent in an optical fiber helps to reduce the hydrogen sensitivity in the drawn optical fiber. More specifically, the reducing agent reduces the concentration of non-bridging oxygen defect centers, which reduces the hydrogen sensitivity. Such hydrogen sensitivity may derive from the increased draw temperature associated with a reduced draw tension. As noted above, although the reduced draw tension does increase hydrogen sensitivity, it also helps to lower attenuation in the drawn fiber. The lower the attenuation in an optical fiber, the more efficient the fiber can transmit a signal.

Regulating the temperature of optical fiber 10 downstream of the draw furnace (such as draw furnace 102) also helps to reduce the attenuation in the drawn fiber. More specifically, regulating the temperature of optical fiber 10 downstream of the draw furnace helps in thermally annealing the type of glass defects that contribute to the attenuation, as well as different types of defects that contribute to the hydrogen sensitivity. With reference again to FIG. 2, in some embodiments, cooling apparatus 128 regulates the temperature of the fiber to further reduce attenuation in the drawn fiber. Cooling apparatus 128 may heat and/or cool fiber 10 as the fiber passes through cooling apparatus 128. In some embodiments, cooling apparatus 128 operates at a temperature between about 900° C. and about 1300° C., or between about 900° C. and about 1200° C., or between about 1000° C. and about 1150° C., or between about 1050° C. and about 1125° C. The temperature of fiber 10 upon entering cooling apparatus 128 may be between about 1050° C. and about 1300° C., or between about 1100° C. and about 1250° C., or between about 1150° C. and about 1200° C. A cooling/heating rate of fiber 10 within cooling apparatus 128 is at a rate of about 1000° C./sec and about 5000° C./sec, or between about 1500° C./sec and about 3500° C./sec, or between about 2000° C./sec and about 3000° C./sec. Fiber 10 may be exposed to the heating/cooling treatment of cooling apparatus 128 for a duration of about 0.05 seconds or longer, or about 0.08 seconds or longer, or about 0.10 seconds or longer, or about 0.20 seconds or longer, or about 0.30 seconds or longer, or about 0.50 seconds or longer. Additionally or alternatively, fiber 10 may be exposed to the heating/cooling treatment of cooling apparatus 128 for a duration of about 4 seconds or less, or about 3 seconds or less, or about 2 seconds or less, or about 1 second or less, or about 0.90 seconds or less. In some embodiments, the duration is about 0.05 seconds to about 2 seconds, or about 0.08 seconds to about 1 second, or about 0.10 seconds to about 0.80 seconds, or about 0.40 seconds to about 0.60 seconds.

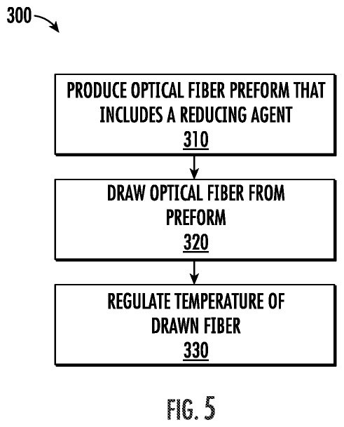

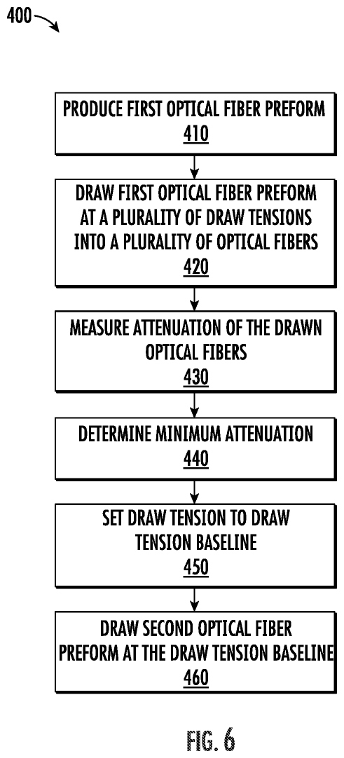

Embodiments of the present disclosure also comprise a process 300, as shown in FIG. 5 to produce optical fiber 10 with reduced attenuation. Step 310 of process 300 comprises the step of producing an optical fiber preform that includes a reducing agent. Therefore, step 310 may be performed according to the steps of process 200. As discussed above, the reducing agent may be incorporated during the halide-doping step and/or during the consolidation step of process 200. Therefore, for example, in some embodiments, the reducing agent is incorporated into the cladding (e.g., inner cladding 14) of the optical fiber preform as a gas simultaneously with the halide-containing gas. In some embodiments, the halide is fluorine. Furthermore, the preform may have an alkali-doped core. In step 320 of process 300, the optical fiber is drawn from the optical fiber preform using system 100. The drawing of the optical fiber may be accomplished by tractor 140, as discussed above, operating with a draw tension ranging from about 50 grams to about 100 grams (or any of the draw tensions discussed above). Furthermore, in step 330 of process 300, the temperature of the drawn fiber is regulated by cooling apparatus 128 downstream of draw furnace 102. As discussed above, the cooling apparatus 128 may operate in a range from about 900° C. to about 1300° C. (or any of the temperatures discussed above). Process 330 may produce optical fiber 10 with reduced attenuation while also maintaining a low number of oxygen-rich non-bridging oxygen defects.

FIG. 6 depicts another process 400 to produce an optical fiber with reduced attenuation. In step 410 of process 400, a first optical fiber is produced. The first optical fiber preform may be produced according to the above disclosed steps of process 200. Therefore, the first optical fiber preform comprises an alkali-doped core and a reducing agent-doped cladding, as discussed above. In step 420, the first optical fiber preform is drawn at a plurality of draw tensions into a plurality of optical fibers. For example, in step 420, (i) the first optical fiber preform may be drawn at a first draw tension (e.g., 100 grams) into a first optical fiber, (ii) the first optical fiber preform may be drawn at a second draw tension (e.g., 90 grams) into a second optical fiber, (iii) the first optical fiber preform may be drawn at a third draw tension (e.g., 80 grams) into a third optical fiber, and (iv) the first optical fiber preform may be drawn at a fourth draw tension (e.g., 70 grams) into a fourth optical fiber. In some embodiments, each of the plurality of draw tensions are different from each other. Therefore, for example, the first, second, third, and fourth draw tensions are each a different and distinct draw tension. Step 420 may be accomplished using system 100, including cooling apparatus 128.

Then, at step 430, the attenuation of each of the drawn optical fibers is measured. For example, the attenuation of each of the first, second, third, and fourth optical fibers is measured. At step 440, the minimum attenuation of the measured attenuations is determined. For example, it may be determined that the fourth optical fiber has the lowest measured attenuation of the optical fibers. At step 450, the draw tension of system 100 is set to a draw tension baseline, such that the draw tension baseline corresponds to the draw tension of the optical fiber with the lowest attenuation. Therefore, in the above example, the draw tension baseline would be a tension of 70 grams since, in this example, the fourth optical fiber had the minimum attenuation and was drawn at a tension of 70 grams. In this example, system 100 would then be set to the draw tension baseline of 70 grams.

At step 460 of process 400, a second optical fiber preform is drawn from system 100 at the draw tension baseline. The second optical fiber preform is produced by the same process as that of the first optical fiber preform. In the above example, the second optical fiber preform is drawn at the draw tension baseline of 70 grams.

The draw tension baseline provides the optimized draw tension to achieve the lowest attenuation. Therefore, in the embodiments of process 400, the first optical fiber preform is used to determine the draw tension baseline. This draw tension baseline is then used to draw the second optical fiber preform so that the second optical fiber preform can be drawn with superior attenuation attributes. Process 400 provides an efficient system to determine an optimal draw tension to produce superior attenuation attributes in a drawn optical fiber.

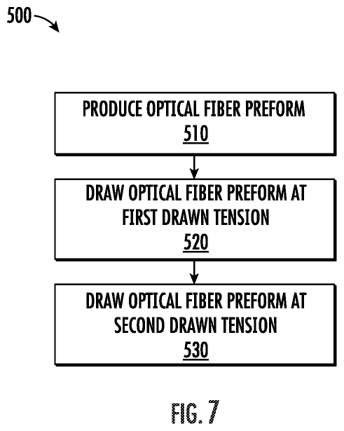

Embodiments of the present disclosure also comprise changing the draw tension while drawing an optical fiber preform in order to provide a drawn optical fiber with reduced attenuation. More specifically, as shown in FIG. 7, process 500 comprises producing an optical fiber preform (step 510). The optical fiber preform may be produced according to the above disclosed steps of process 200. Therefore, the optical fiber preform comprises an alkali-doped core and a reducing agent-doped cladding, as discussed above. In step 520, a first portion of the optical fiber preform is drawn at a first draw tension into a first optical fiber. In step 530, a second portion of the optical fiber preform is drawn at a second draw tension into a second optical fiber. Therefore, process 500 comprises changing the draw tension (while drawing the optical fiber preform) from a first draw tension to a second draw tension, wherein the second draw tension may be lower than the first draw tension. Accordingly, the single optical fiber preform experiences both the first and second draw tensions.

In some embodiments, the second draw tension is lower than the first draw tension. Furthermore, in some embodiments, each of the first and second draw tension are ranges. The first and second draw tensions may be any of the ranges disclosed above. In some embodiments, the first draw tension is in a range from about 100 grams to about 200 grams, or about 100 grams to about 150 grams. Additionally or alternatively, in some embodiments, the second draw tension is in a range from about 40 grams to about 90 grams, or from about 60 grams to about 80 grams. The first draw tension may be larger than the second draw tension by a difference of about 10 grams or more, or about 10 grams or more, or about 15 grams or more, or about 20 grams or more, or about 25 grams or more, or about 30 grams or more.

In some embodiments of process 500, about 50% or less of a length of the optical fiber preform is drawn with the first draw tension. In other embodiments, about 40% or less, or about 30% or less, or about 20% or less, or about 15% or less, or about 10% or less, or about 5% or less, or about 2.5% or less, or about 2% or less, or about 1% or less the length of the optical fiber preform is drawn with the first draw tension. Therefore, about 50% or more of the length of the optical fiber preform is drawn with the second draw tension. In other embodiments, about 60% or more, or about 70% or more, or about 75% or more, or about 80% or more, or about 85% or more, or about 90% or more, or about 95% or more, or about 97.5% or more, or about 98% or more, or about 99% or more of the length of the optical fiber preform is drawn with the second draw tension.

The optical fibers produced according to the methods disclosed herein have an attenuation at 850 nm of about 1.50 dB/km or less, or about 1.45 dB/km or less, or about 1.40 dB/km or less, or about 1.38 dB/km or less, or about 1.37 dB/km or less, or about 1.36 dB/km or less, or about 1.35 dB/km or less, or about 1.34 dB/km or less, or about 1.32 dB/km or less, or about 1.31 dB/km or less, or about 1.30 dB/km or less. In some embodiments, the optical fibers produced herein have an attenuation at 850 nm between about 1.50 dB/km and about 1.30 dB/km, or about 1.45 dB/km and about 1.31 dB/km, or about 1.40 dB/km and about 1.32 dB/km. In some embodiments, the optical fibers produced herein have an attenuation at 850 nm of 1.387 dB/km or 1.389 dB/km.

Furthermore, the optical fibers produced according to the methods disclosed herein have an attenuation at 1550 nm of about 0.155 dB/km or less, or about 0.150 dB/km or less, or about 0.145 dB/km or less, or about 0.140 dB/km or less, or about 0.138 dB/km, or about 0.135 dB/km, or about 0.130 dB/km. In some embodiments, the optical fibers produced herein have an attenuation at 1550 nm between about 0.155 dB/km and about 0.130 dB/km, or about 0.150 dB/km and about 0.135 dB/km, or about 0.145 dB/km and about 0.138 dB/km.

Therefore, the optical fibers produced according to the methods disclosed herein have the low attenuations disclosed above at wavelengths of both 850 nm and 1550 nm. The low attenuation at 850 nm is advantageous for commercial use, as most commercial systems operate at a wavelength at 850 nm. Furthermore, the low attenuation at 1550 nm is advantageous to determine the hydrogen sensitivity of the fiber, as most hydrogen defects absorb wavelengths at 1550 nm.

Furthermore, the optical fibers produced according to the methods disclosed herein have an effective area of about 160 micron² or less at 1550 nm. In some embodiments, the effective area is about 150 micron² or less, or about 140 micron² or less, or about 130 micron² or less, or about 120 micron² or less, or about 110 micron² or less, or about 100 micron² or less, or about 90 micron² or less, or about 80 micron² or less at 1550 nm. In yet some other embodiments, the effective area is between about 70 micron² and about 160 micron² at 1550 nm. In some embodiments, the effective area at 1550 nm is between about 75 micron² and about 155 micron², or between about 80 micron² and about 150 micron², or between about 85 micron² and about 150 micron², or between about 90 micron² and about 145 micron², or between about 95 micron² and about 140 micron², or between about 100 micron² and about 135 micron², or between about 105 micron² and about 130 micron², or between about 110 micron² and about 125 micron², or between about 115 micron² and about 120 micron², or a combination of ranges with any of these values as endpoints.

Furthermore, the optical fibers disclosed herein have a mode field diameter, at 1550 nm wavelength, in a range of about 10.0 microns to about 15.0 microns, or from about 11.0 microns to about 14.0 microns, or from about 11.0 microns to about 13.0 microns. In some embodiments, the mode field diameter, at 1550 nm wavelength, is about 11.5 microns, or about 13.0 microns.

The cable cutoff of the optical fibers disclosed herein is about 1530nm or less, or about 1500 nm or less, or about 1450 nm or less, or about 1400 nm or less.

According to an aspect of the present disclosure, the optical fibers have a dispersion at 1550 nm of less than 22 ps/nm/km and a dispersion slope at 1550 nm of less than 0.1 ps/nm²/km. For example, the dispersion at 1550 nm can be from about 15 ps/nm/km to about 22 ps/nm/km, about 16 ps/nm/km to about 22 ps/nm/km, about 16 ps/nm/km to about 21 ps/nm/km, about 17 ps/nm/km to about 21 ps/nm/km, about 17 ps/nm/km to about 20 ps/nm/km.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of manufacturing an optical fiber, the method comprising:
forming an alkali-doped silica-containing glass tube;
collapsing the glass tube to form a first glass rod;
depositing silica soot on the first glass rod to form a first glass body;
depositing additional silica soot on the first glass body;
exposing the silica soot on the first glass body to a halide dopant;
exposing the silica soot on the first glass body to a reducing agent;
consolidating the silica soot on the first glass body to form a first preform precursor;
forming a first optical fiber preform from the first preform precursor;
drawing the first optical fiber preform at a first draw tension to produce a first alkali doped optical fiber and drawing the first optical fiber preform at a second draw tension to produce a second alkali doped optical fiber;
measuring the attenuation of the first alkali doped optical fiber and the second alkali doped optical fiber such that the first alkali doped optical fiber has a first measured attenuation and the second alkali doped optical fiber has a second measured attenuation, the second measured attenuation being less than the first measured attenuation;
setting the draw tension to the second draw tension; and
drawing a second optical fiber preform at the second draw tension to produce a third alkali doped optical fiber,
wherein the third alkali-doped optical fiber has an attenuation at 850 nm of about 1.50 dB/km or less and an attenuation at 1550 nm of about 0.155 dB/km or less.

2. The method of claim 1, wherein the first optical fiber preform and the second optical fiber preform are made by the same process.

3. The method of claim 1, further comprising exposing silica soot of the second optical fiber preform to the halide dopant and to the reducing agent

4. The method of claim 1, wherein the first glass rod is doped with an alkali comprising at least one of sodium, potassium, and rubidium.

5. The method of claim 1, wherein the reducing agent is carbon monoxide (CO), silicon tetrachloride (SiCl₄), chloromethane (CH₃Cl), dichloromethane (CH₂Cl₂), chloroform (CHCl₃), or mixtures thereof.

6. The method of claim 1, further comprising drawing the second optical fiber preform at a draw tension of about 60 grams to about 90 grams.

7. The method of claim 1, wherein the attenuation at 850 nm is about 1.45 dB/km or less.

8. The method of claim 7, wherein the attenuation at 850 nm is about 1.40 dB/km or less.

9. The method of claim 1, wherein the attenuation at 1550 nm is about 0.150 dB/km or less.

10. The method of claim 9, wherein the attenuation at 1550 nm is about 0.145 dB/km or less.

11. A method of manufacturing an optical fiber, the method comprising:
forming an alkali-doped silica-containing glass tube;
collapsing the glass tube to form a glass rod;
depositing silica soot on the glass rod to form a glass body;
depositing additional silica soot on the glass body;
exposing the silica soot on the glass body to a halide dopant;
exposing the silica soot on the glass body to a reducing agent;
consolidating the silica soot on the glass body to form a preform precursor;
forming an optical fiber preform from the preform precursor;
drawing the optical fiber preform into an alkali-doped optical fiber at a draw tension of about 60 grams to about 90 grams; and
exposing the alkali-doped optical fiber to a cooling apparatus for a duration of about 0.05 seconds or greater, the cooling apparatus being downstream of a draw furnace and operating within a range between about 900° C. and about 1300° C.,
wherein the alkali-doped optical fiber has an attenuation at 850 nm of about 1.50 dB/km or less and an attenuation at 1550 nm of about 0.155 dB/km or less.

12. The method of claim 11, wherein the glass rod is doped with an alkali comprising at least one of sodium, potassium, and rubidium.

13. The method of claim 11, wherein the reducing agent is carbon monoxide (CO), silicon tetrachloride (SiCl₄), chloromethane (CH₃Cl), dichloromethane (CH₂Cl₂), chloroform (CHCl₃), or mixtures thereof.

14. The method of claim 13, wherein the reducing agent is carbon monoxide (CO) or silicon tetrachloride (SiCl₄).

15. The method of claim 11, wherein the alkali-doped optical fiber is exposed to the cooling apparatus for a duration from about 0.05 seconds to about 2 seconds.

16. The method of claim 11, wherein the silica soot on the glass body is exposed to the halide dopant and the reducing agent simultaneously.

17. The method of claim 16, wherein the reducing agent is incorporated with a carrier gas to form a mixed gas, the mixed gas comprising between about 500 ppm and about 20,000 ppm of the reducing agent.

18. The method of claim 17, wherein the mixed gas comprises between about 2000 ppm and about 5500 ppm of the reducing agent.

19. The method of claim 16, wherein the halide is fluorine.

20. A method of manufacturing an optical fiber, the method comprising:
forming an alkali-doped silica-containing glass tube;
collapsing the glass tube to form a glass rod;
depositing silica soot on the glass rod to form a glass body;
depositing additional silica soot on the glass body;
exposing the silica soot on the glass body to a halide dopant;
exposing the silica soot on the glass body to a reducing agent;
consolidating the silica soot on the glass body to form a preform precursor;
forming an optical fiber preform from the preform precursor;
drawing a first portion of the optical fiber preform into a first alkali-doped optical fiber at a first draw tension; and
drawing a second portion of the optical fiber preform into a second alkali-doped optical fiber at a second draw tension,
wherein the first draw tension is higher than the second draw tension, and
wherein the second alkali-doped optical fiber has an attenuation at 850 nm of about 1.50 dB/km or less and an attenuation at 1550 nm of about 0.155 dB/km or less.
